(19) United States
(12) Patent Application Publication
(10) Pub. No.: US 2018/0157800 A1
(43) Pub. Date: Jun. 7, 2018

(54) METHODS AND SYSTEMS FOR USER DEFINED DISTRIBUTED LEARNING MODELS FOR MEDICAL IMAGING

(71) Applicant: General Electric Company, Schenectady, NY (US)

(72) Inventors: Hariharan Ravishankar, Bangalore (IN); Vivek Vaidya, Bangalore (IN); Christian Fritz Perrey, Zipf (AT)

(21) Appl. No.: 15/828,936

(22) Filed: Dec. 1, 2017

(30) Foreign Application Priority Data
Dec. 2, 2016 (IN) 201641041218

(51) Int. Cl. G06F 19/00

(52) U.S. Cl. CPC G06F 19/345; G09B 7/00; G06F 19/321

(57) ABSTRACT

Systems and methods are provided for user defined distributed learning models grouped based on user clusters for configuring settings of a medical diagnostic imaging system. The systems and methods are configured to maintain models with predetermined settings for at least one of system settings, image presentation settings, or anatomical structures. The systems and methods are configured to calculate a data value representing select user preferences for a first user, identifying a first cluster based on the data value, and assigning a first model from the models to the first user based on the first cluster. The systems and methods are configured to monitor use of the first model by the first user during a medical diagnostic application to determine whether the first model is updated by the first user or automatically during the medical diagnostic application by changing at least one of system settings, image presentation settings, or anatomical structures.

### FIELD

Embodiments described herein generally relate to user defined distributed learning models grouped based on user clusters for configuring settings of a medical diagnostic imaging system.

### BACKGROUND OF THE INVENTION

A machine learning network, such as deep neural networks, involve various algorithms that define an initial model based on training data. The machine learning network automatically adjusts the initial model based on user feedback received from a plurality of client systems. Conventional machine learning networks may include a centralized system to receive user feedback from multiple client devices. For example, each of the client devices receive and are trained by the model from the centralized system. The client device receives user feedback from the user operating the client system. The user feedback is received by the centralized system, which is utilized to train and/or update the model based on the user feedback. However, the model determined using the conventional machine learning networks treats all users as a homogenous group having equivalent preferences. Additionally, the user feedback is qualitative relative to the model utilized by the client device. Further, the user feedback is only available at discrete and manpower intensive time points. For example, the user feedback is aggregated for the entire model requiring predetermined time points to transmit the user feedback to the centralized system.

### BRIEF DESCRIPTION OF THE INVENTION

In an embodiment a computer implemented method is provided. The method includes maintaining models with predetermined settings for at least one of system settings, image presentation settings, or anatomical structures. The method includes calculating a data value representing select user preferences for a first user, identifying a first cluster based on the data value, and assigning a first model from the models to the first user based on the first cluster. The method further includes monitoring use of the first model by the first user during a medical diagnostic application to determine whether the first model is updated by the first user or automatically during the medical diagnostic application by changing at least one of system settings, image presentation settings, or anatomical structures.

In an embodiment a system (e.g., a distributed learning central system) is provided. The system includes a communication circuit communicatively coupled to a plurality of medical diagnostic imaging systems. The system includes a controller circuit. The controller circuit is configured to maintain models with predetermined settings for at least one of system settings, image presentation settings, or anatomical structures, calculate a data value representing select user preferences for a first user, and identify a first cluster based on the data value. The controller circuit is further configured to assign a first model from the models to the first user based on the first cluster, and monitor use of the first model by the first user during a medical diagnostic application to determine whether the first model is updated by the first user by changing at least one of system settings, image presentation settings, or anatomical structures.

In an embodiment a tangible and non-transitory computer readable medium comprising one or more programmed instructions is provided. The one or more programmed instructions are configured to direct one or more processors to maintain models with predetermined settings for at least one of system settings, image presentation settings, or anatomical structures. The one or more programmed instructions are further configured to calculate a data value representing select user preferences for a first user, identify a first cluster based on the data value, and assign a first model from the models to the first user based on the first cluster. The one or more programmed instructions are further configured to monitor use of the first model by the first user during a medical diagnostic application to determine whether the first model is updated by the first user by changing at least one of system settings, image presentation settings, or anatomical structures.

### BRIEF DESCRIPTION OF THE DRAWINGS

FIG. 1 illustrates a schematic block diagram of an embodiment of a medical machine learning system.

FIG. 2 illustrate a schematic block diagram of an embodiment of a distribution learning central system.

FIG. 3 illustrates a graphical representation of data values grouped into corresponding user clusters, in accordance with an embodiment.

FIG. 4 illustrates a flowchart of an embodiment of a method for a user defined distributed learning model.

FIG. 5 illustrates a schematic block diagram of an embodiment of a medical diagnostic imaging system.

FIG. 6 illustrates a graphical representation of data values grouped into corresponding user clusters, in accordance with an embodiment.

### DETAILED DESCRIPTION OF THE INVENTION

The following detailed description of certain embodiments will be better understood when read in conjunction with the appended drawings. To the extent that the figures illustrate diagrams of the functional modules of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like). Similarly, the programs may be stand-alone programs, may be incorporated as subroutines in an operating system, may be functions in an installed software package, and the like. It should be understood that the various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Various embodiments described herein generally relate to user defined distributed learning models grouped based on user clusters for configuring settings of a medical diagnostic imaging system. For example, a medical machine learning system is provided herein. The medical machine learning system is configured to cluster similar user preferences or different target anatomies selected by the user. The different clusters may be utilized to define a model for each user having similar user preferences. The user preferences or target anatomies are based on pre-processing user guidance such as from a data value acquired by the medical machine learning system based on inputs received from pre-determined questions (e.g., from a questionnaire) by a user filled on a clinical application and/or the medical diagnostic imaging system. The medical machine learning system is configured to parse the user preferences for example utilizing natural language processing neural nets to different clusters, and to assign a model for the user based on the user cluster. By providing user feedback of the model being used by the medical diagnostic imaging system, the medical machine learning system may refine the user clusters of the user based on the user feedback. Additionally or alternatively, the medical machine learning system may automatically reassign to an alternative user cluster of the user based on the user feedback.

A technical effect of at least one embodiment described herein provide customized models in a cost effective manner A technical effect of at least one embodiment described here in provides increased user satisfaction by addressing user feedback fast relative to conventional machine learning networks.

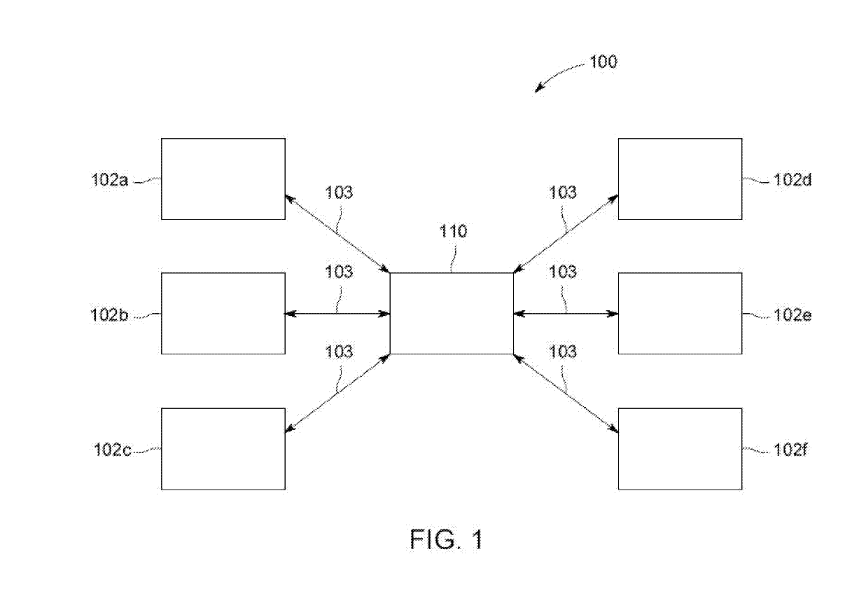

FIG. 1 is a schematic block diagram of an embodiment of a medical machine learning system (MMLS) 100. The MMLS 100 includes a plurality of medical diagnostic imaging systems 102a-f communicatively coupled to a distributed learning central system (DLCS) 110. For example, the DLCS 110 may be communicatively coupled to the medical diagnostic imaging systems 102a-f via bi-directional communication links 103. The bi-directional communication links 103 may be a wired (e.g., via a physical conductor) and/or wireless communication (e.g., utilizing radio frequency (RF)) link for exchanging data (e.g., data packets) between the DLCS 110 and one or more of the medical diagnostic imaging systems 102a-f. For example, the DLSC 110 may receive user feedback from one or more user of the medical diagnostic imaging systems 102a-f, receive user preferences of one or more users, and/or the like from one or more medical diagnostic imaging systems 102a-f along the bi-directional communication links 103. In another example, the medical diagnostic imaging systems 102a-f may receive models from the DLSC 110 along the bi-directional communication links 103. The bi-directional communication links 103 may be based on a standard communication protocol, such as Ethernet, TCP/IP, WiFi, 802.11, and/or a customized communication protocol. The DLCS 110 may be configured to maintain a plurality of models for the medical diagnostic imaging systems 102a-f. The models may include predetermined settings of the medical diagnostic imaging systems 102a-f. The predetermined settings may represent system settings, image presentation settings, and/or anatomical structures of the medical diagnostic imaging systems 102a-f. The medical diagnostic imaging systems 102a-f may include ultrasound imaging systems or devices, nuclear medicine imaging devices (e.g., Positron Emission Tomography (PET) or Single Photon Emission Computed Tomography (SPECT) imaging systems), Magnetic Resonance (MR) imaging devices, Computed Tomography (CT) imaging devices, and/or x-ray imaging devices, and/or the like. Each of the medical diagnostic imaging system 102a-f may be configured to perform one or more medical diagnostic applications. The medical diagnostic application may represent a scan and/or acquisition of information (e.g., medical data, image data) of a patient. For example, one of the medical diagnostic imaging systems 102a-f may be an ultrasound imaging system such that the medical diagnostic applications may include an abdominal scan, a fetal anatomical scan, cardiovascular scan, vaginal scan, bladder scan, and/or the like. In another example, one of the medical diagnostic imaging systems 102a-f may be a CT imaging device such that the medical diagnostic applications may include urinary tract scan, thoracic spine scan, cranial scan, CAT, cervical spine scan, blood vessel scan, pelvis scan, and/or the like.

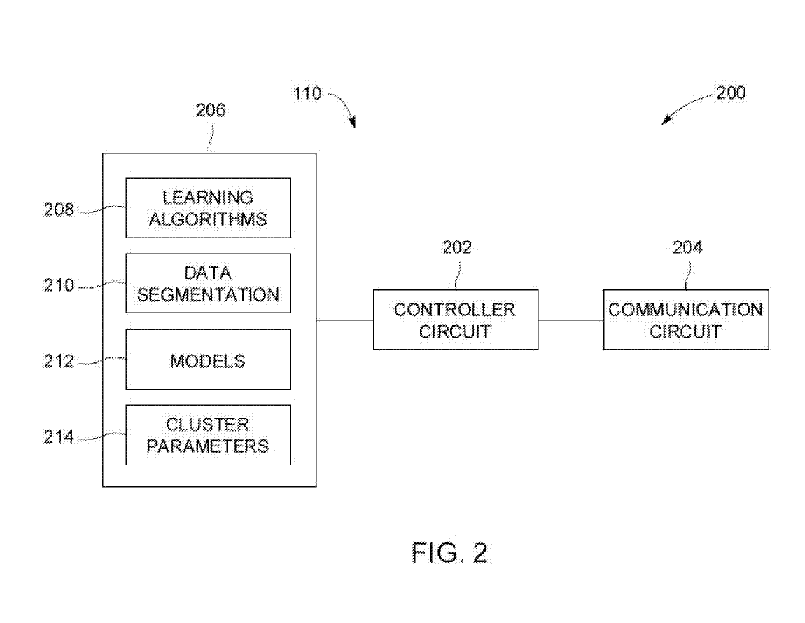

FIG. 2 is a schematic block diagram 200 of an embodiment of the DLCS 110. The DLCS 110 includes a controller circuit 202 configured to control the operation of the DLCS 110. The controller circuit 202 may include and/or represent one or more hardware circuits or circuitry that include, are connected with, or that both include and are connected with one or more processors, controllers, and/or other hardware logic-based devices. Additionally or alternatively, the controller circuit 202 may execute one or more programmed instructions stored on a tangible and non-transitory computer readable medium (e.g., memory 206) to perform one or more operations as described herein.

The controller circuit 202 may be operably coupled to and/or control a communication circuit 204. The communication circuit 204 is configured to receive and/or transmit information with one or more medical diagnostic imaging systems 102a-f. The communication circuit 204 may represent hardware that is used to transmit and/or receive data along the bi-directional communication links 103. The communication circuit 204 may include a transceiver, receiver, transceiver and/or the like and associated circuitry (e.g., antennas) for wired and/or wirelessly communicating (e.g., transmitting and/or receiving) with one or more medical diagnostic imaging systems 102a-f. For example, protocol firmware may be stored in the memory 206, which is accessed by the controller circuit 202. The protocol firmware provides the network protocol syntax for the controller circuit 202 to assemble data packets, establish and/or partition data received along the bi-directional communication links 103, and/or the like.

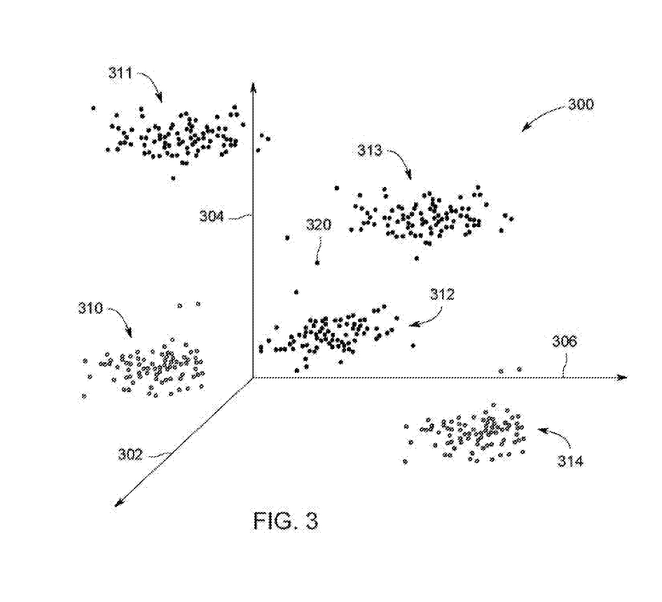

The memory 206 includes parameters, algorithms, models, data values, and/or the like utilized by the controller circuit 202 to perform one or more operations described herein. For example, the memory 206 includes a set of machine learning algorithms 208 (e.g., convolutional neural network algorithms, deep learning algorithms, decision tree learning algorithms, and/or the like). The machine learning algorithms 208 may be configured to define one or more models that are configured to provide the predetermined settings utilized to configure the medical diagnostic imaging systems 102a-f based on the user preferences. The models are defined based on select user preferences within user clusters, such as user clusters 310-314 shown in FIG. 3. The user clusters 310-314 may represent a group of data values representing the select user preferences of the plurality of users.

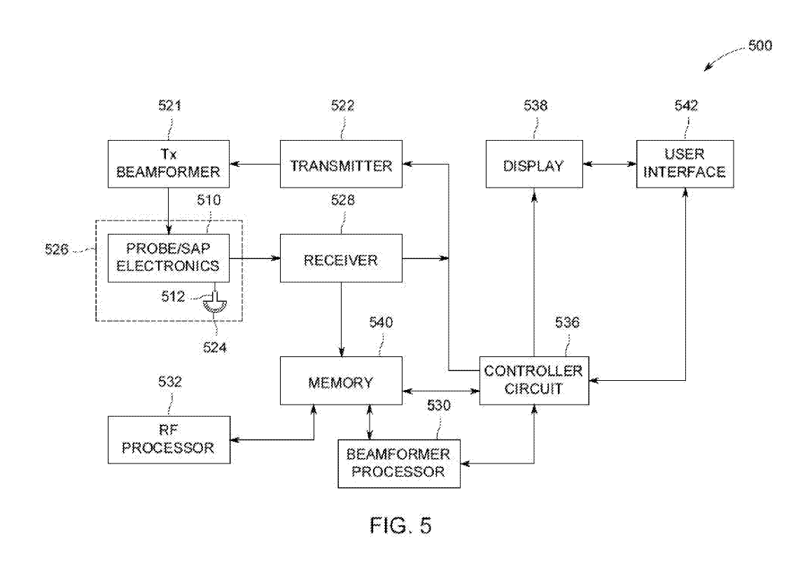

FIG. 3 illustrates a graphical representation 300 of data values identified into corresponding user clusters 310-314, in accordance with an embodiment. The user clusters 310-314 represent groupings of data values based on the select user preferences of the user. The select user preferences may be collected by the DLCS 110 based on predetermined questions submitted to the user, such as included within a questionnaire. For example, the answers to the predetermined questions may be entered by the user into the medical diagnostic imaging system 102a-f using a user interface (e.g., a user interface 542 of FIG. 5), and received by the DLCS 110 via at least one of the corresponding bi-directional communication link 103.

The controller circuit 202 may be configured to parse the select user preferences from the responses to the predetermined questions thereby to identify the select user preferences of the one or more users. For example, the controller circuit 202 may execute a data segmentation algorithm 210 stored in the memory 206. The data segmentation algorithm 210 may represent a set of machine learning algorithms, such as a natural language processing neural net, configured to identify terms and/or word structures representing user preferences for the medical diagnostic imaging system 102a-f from the user responses.

For example, the controller circuit 202 when executing the data segmentation algorithm 210 is configured to identify words and/or answer structures representing the select user preferences, such as anatomical structures (e.g., cardiac structure, heart, kidney, bladder, brain, bone structure, and/or the like), visualization preferences (e.g., enhanced edges, smoother output, speckle imaging, contrast selections, brightness level, range of pixels, and/or the like), patient specifics (e.g., age, fetal, adult, child, and/or the like), and/or the like from the answers submitted by the user. The select user preferences may represent a portion of the user preference that are tracked by the controller circuit 202, and utilized to define the models 212.

The controller circuit 202 may identify the words and/or answer structures to calculate a data value representing the one or more select user preferences. For example, the controller circuit 202 may determine that the select user preferences include the anatomical structure of a fetal heart. The controller circuit 202 is configured to calculate a value representing the fetal heart different from and/or distinct from alternative user preferences representing anatomical structures such as the uterus, bladder, lungs, and/or the like. The data value representing one or more select user preferences may be stored in the memory 206. The models 212 maintained by the controller circuit 202 may be defined based on the groups of data values having similar and/or the same select user preferences into the user clusters 310-314. For example, each of the models 212 are distinct and/or different from each other defined from the select user preferences within the user clusters 310-314.

Additionally or alternatively, the select user preferences may be automatically collected by the DLCS 110 based on selections by the user. For example, the user may select a plurality of images on one or more of the medical diagnostic imaging systems 102a-f. The plurality of images may be acquired by the user utilizing the medical diagnostic imaging system 102a-f and/or represent a portion of template images stored by the medical diagnostic imaging system 102a-f. Each of the images may represent select user preferences. For example, based on the plurality of images from the template images selected by the user the controller circuit 202 may be configured to determine the select user preferences of the user. In another example, the controller circuit 202 may automatically analyze the plurality of images acquired by the user to determine the select user preferences of the user.

The graphical representation 300 (FIG. 3) includes data values plotted along three axes 302, 304, 306. The axes 302, 304, 306 may correspond to one or more select user preferences. The select user preferences may represent the user preference tracked by the controller circuit 202 to group the user into the user clusters 310-314. For example, the axis 302 may represent a resolution, the axis 304 may represent edge contrast, and the axis 306 may represent anatomical structure. The data values may be calculated by the controller circuit 202 from multiple users of the medical diagnostic imaging systems 102a-f. Based on the data values of the users relative to each other (e.g., positon along the axes 302, 304, 306), the controller circuit 202 may group the data values into separate user clusters 310-314.

For example, the controller circuit 202 may be configured to utilize K-means clustering to iteratively group the data values into K clusters. The controller circuit 202 may identify K cluster centers, either randomly or based on some heuristic technique. The controller circuit 202 is configured to assign each data value to one of the user clusters 310-314 that minimizes the variance between the data values and the cluster center. For example, the variance may be the squared or absolute difference between each data value and a cluster center. Additionally or alternatively, the variance may be based on a predetermined threshold stored in the memory 208. For example, the predetermined threshold may represent a distance between the center of the user cluster and the data values to define a size of the clusters 310-314 and/or number of the clusters 310-314. The controller circuit 202 re-calculates the cluster centers by averaging all of the data values in each of the clusters 310-314. Optionally, the controller circuit 202 may iteratively repeat the assigning operation of each data value, and the re-calculation of the cluster centers until convergence (e.g., no change of data values to different clusters). The size of the user clusters 310-314, the select user parameters for the user clusters 310-314, the predetermined threshold, and/or the like relating to the user clusters 310-314 may be stored in the cluster parameters 214 in the memory 206. It may be noted that the controller circuit 202 may be configured to utilize alternative clustering methods such as distribution-based clustering, histogram clustering, density-based clustering, and/or the like.

The user clusters 310-314 may include data values for the select user preference of multiple users. The controller circuit 202 may be configured to assign select models from the models 212 to each user based on the corresponding user clusters 310-314 of the user. The models 212 assigned to each user cluster 310-314 are assigned and/or updated based on feedback from the users within the user clusters 310-314.

For example, the controller circuit 202 is configured to monitor the use of a model assigned to the users of the user cluster 314 of the medical diagnostic imaging systems 102a-f by identifying when adjustments to the predetermined settings are made by one or more users. The controller circuit 202 receives adjustments to the predetermined settings of the model by one or more users of the user cluster 314 via at least one of the bi-directional communication links 103. The adjustment to the predetermined settings represents user feedback based on the configuration by the model. The controller circuit 202 is configured to adjust the data values of one or more users based on the adjustment to the predetermined settings of the one or more users. Based on the adjustment of the data values, the controller circuit 202 is configured to update the model utilizing the machine learning algorithms 208 based on the data values within the user cluster 314 to account for the feedback of the users corresponding to the adjustment in predetermined settings.

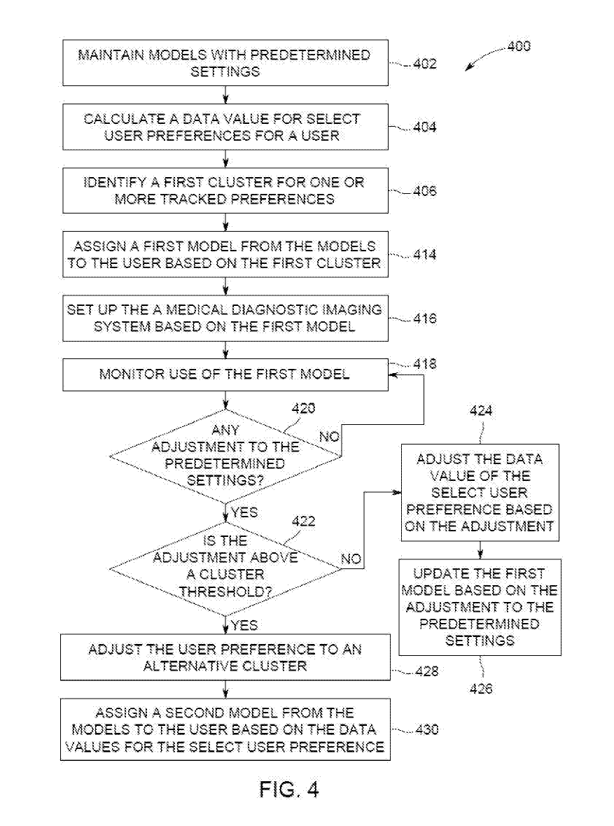

As further described in connection with FIG. 4, the controller circuit 202 is configured to maintain the models 212 based on adjustments to the predetermined settings by one or more users.

FIG. 4 a flowchart of a method 400 for a user defined distributed learning model generating a visualization plane, in accordance with an embodiment. The method 400, for example, may employ structures or aspects of various embodiments (e.g., systems and/or methods) discussed herein. In various embodiments, certain steps (or operations) may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion. In various embodiments, portions, aspects, and/or variations of the method 400 may be used as one or more algorithms to direct hardware to perform one or more operations described herein. It may be noted, that operations (e.g., 402-430) of the method 400 may be repeated for multiple users concurrently and/or simultaneously by the controller circuit 202.

Beginning at 402, the DLCS 110 is configured to maintain the models 212 with the predetermined settings. For example, the memory 206 of the DLCS 110 stores the models 212 in the memory 206, which is utilized by the medical diagnostic imaging systems 102a-f (FIG. 1). The predetermined settings may include at least one of system settings, image presentation settings, and/or anatomical structures for the medical diagnostic imaging systems 102a-f. Additionally or alternatively, as further described at 426, the controller circuit 202 is configured to update and/or adjust the models 212 based on user feedback received from the medical diagnostic imaging systems 102a-f via the bi-directional communication links 103.

At 404, the controller circuit 202 is configured to calculate a data value representing select user preferences for a user. For example, the user preferences are received by the DLCS 110 via at least one of the bi-directional communication links 103. The user preferences may be based on responses by the user from a set of predetermined questions received by the DLCS 110. The controller circuit 202 may identify the select user preferences from the user preferences by executing the data segmentation algorithm 210 stored in the memory 206 to identify words and/or answer structures representing the user preferences such as anatomical structures (e.g., cardiac structure, heart, kidney, bladder, brain, bone structure, and/or the like), visualization preferences (e.g., enhanced edges, smoother output, speckle imaging, contrast selections, brightness level, range of pixels, and/or the like), patient specifics (e.g., age, fetal, adult, child, and/or the like), and/or the like to parse the select user preferences of the user to calculate the data value representative of the select user preferences. Additionally or alternatively, the controller circuit 202 may automatically identify the select user preferences based on images selected and/or acquired by the user. Based on the select user preferences identified by the controller circuit 202, the controller circuit 202 may calculate a data value. Each of the data values may correspond to one or more select user preferences utilized by the controller circuit 202 to define the models 212.

Optionally, the controller circuit 202 may collect the data values from the medical diagnostic imaging system 102a-f. For example, the medical diagnostic imaging system 102a-f may transmit the data value corresponding to the select user preferences of the user to the DLCS 110 via the bi-directional communication link 103.

At 406, the controller circuit 202 may identify a first cluster based on the data value. For example, the controller circuit 202 may determine the select preferences of the user is represented by a data value 320 shown in FIG. 3. The controller circuit 202 may be configured to identify K cluster centers, either randomly or based on some heuristic technique, and iteratively adjusting the size and/or number of the user clusters 310-314 until the variance between the data values and the cluster centers are minimized The variance may be the squared or absolute difference between a data value and a cluster center. Additionally or alternatively, the variance may be based on a predetermined threshold stored in the cluster parameters 214 in the memory 206. The controller circuit 202 may identify a first cluster, such as the user cluster 312, for the data value 320 based on the variance to the cluster center of the user cluster 312. The first cluster (e.g., the user cluster 312) may include data values of multiple users.

At 414, the controller circuit 202 is configured to assign a first model from the models 212 to the user based on the first cluster (e.g., the user cluster 312). For example, the controller circuit 202 may identify the select user preferences of the user to the user cluster 312. Each user cluster 310-314 may have corresponding models 212 based on the select user preferences. For example, the separate models 212 stored in the memory 206 are configured and/or designed by the controller circuit 202 executing the machine learning algorithms 208 based on the select user preferences represented by the user clusters 310-314. Based on the select user preferences represented by the data values within the user cluster 312, the controller circuit 202 may assign a first model from the models 212 stored in the memory 206.

At 416, the controller circuit 202 is configured to set up a medical diagnostic imaging system 102a-f based on the first model. For example, the first model includes predetermined settings to configure the medical diagnostic imaging system 102a-f utilized by the user to conform to the select user preferences of the first model. The controller circuit 202 may transmit the first model along the bi-directional communication link 103 to the medical diagnostic imaging systems 102a-f. Based on the first model received from the DLCS 110, a controller circuit 502 (FIG. 5) may adjust at least one of system settings, image presentation settings, and/or anatomical settings to align with the select user preferences.

FIG. 5 is a schematic diagram of one of the diagnostic medical imaging systems 102a-f, such as, an ultrasound imaging system 500. The ultrasound imaging system 500 includes an ultrasound probe 526 having a transmitter 522, transmit beamformer 521 and probe/SAP electronics 510. The probe/SAP electronics 510 may be used to control the switching of the transducer elements 524. The probe/SAP electronics 510 may also be used to group transducer elements 524 into one or more sub-apertures.

The ultrasound probe 526 may be configured to acquire ultrasound data or information from the anatomical structures (e.g., organ, blood vessel, heart) of the patient based on the predetermined settings of the first model. The ultrasound probe 526 is communicatively coupled to the controller circuit 536 via the transmitter 522. The transmitter 522 transmits a signal to a transmit beamformer 521 based on acquisition settings received by the controller circuit 536. The acquisition settings may define an amplitude, pulse width, frequency, and/or the like of the ultrasonic pulses emitted by the transducer elements 524. The transducer elements 524 emit pulsed ultrasonic signals into a patient (e.g., a body). The acquisition settings may be adjusted based on the predetermined settings of the first model. For example, the controller circuit 536 is configured to adjust a gain setting, scan angle, power, time gain compensation (TGC), resolution, and/or the like based on the anatomical structures represented by the predetermined settings of the first model. The signal transmitted by the transmitter 522 in turn drives a plurality of transducer elements 524 within a transducer array 512.

The transducer elements 524 emit pulsed ultrasonic signals into a body (e.g., patient) or volume corresponding to the acquisition settings along one or more scan planes. The ultrasonic signals may include, for example, one or more reference pulses, one or more pushing pulses (e.g., shear-waves), and/or one or more pulsed wave Doppler pulses. At least a portion of the pulsed ultrasonic signals back-scatter from the anatomical structures (e.g., heart, left ventricular outflow tract, breast tissues, liver tissues, cardiac tissues, prostate tissues, neonatal brain, embryo, abdomen, and the like) to produce echoes. The echoes are delayed in time and/or frequency according to a depth or movement, and are received by the transducer elements 524 within the transducer array 512. The ultrasonic signals may be used for imaging, for generating and/or tracking shear-waves, for measuring changes in position or velocity within the anatomic structure, differences in compression displacement of the tissue (e.g., strain), and/or for therapy, among other uses. For example, the probe 526 may deliver low energy pulses during imaging and tracking, medium to high energy pulses to generate shear-waves, and high energy pulses during therapy.

The transducer elements 524 convert the received echo signals into electrical signals which may be received by a receiver 528. The receiver 528 may include one or more amplifiers, an analog to digital converter (ADC), and/or the like. The receiver 528 may be configured to amplify the received echo signals after proper gain compensation and convert these received analog signals from each transducer element 524 to digitized signals sampled uniformly in time. The digitized signals representing the received echoes are stored in memory 540, temporarily. The digitized signals correspond to the backscattered waves receives by each transducer element 524 at various times. After digitization, the signals still may preserve the amplitude, frequency, phase information of the backscatter waves.

Optionally, the controller circuit 536 may retrieve the digitized signals stored in the memory 540 to prepare for the beamformer processor 530. For example, the controller circuit 536 may convert the digitized signals to baseband signals or compressing the digitized signals.

The beamformer processor 530 may include one or more processors. Optionally, the beamformer processor 530 may include a central controller circuit (CPU), one or more microprocessors, or any other electronic component capable of processing inputted data according to specific logical instructions. Additionally or alternatively, the beamformer processor 530 may execute instructions stored on a tangible and non-transitory computer readable medium (e.g., the memory 540) for beamforming calculations using any suitable beamforming method such as adaptive beamforming, synthetic transmit focus, aberration correction, synthetic aperture, clutter reduction and/or adaptive noise control, and/or the like. Optionally, the beamformer processor 530 may be integrated with and/or apart of the controller circuit 536. For example, the operations described being performed by the beamformer processor 530 may be configured to be performed by the controller circuit 536.

The beamformer processor 530 performs beamforming on the digitized signals of transducer elements and outputs a radio frequency (RF) signal. The RF signal is then provided to an RF processor 532 that processes the RF signal. The RF processor 532 may include one or more processors. Optionally, the RF processor 532 may include a central controller circuit (CPU), one or more microprocessors, or any other electronic component capable of processing inputted data according to specific logical instructions. Additionally or alternatively, the RF processor 532 may execute instructions stored on a tangible and non-transitory computer readable medium (e.g., the memory 540). Optionally, the RF processor 532 may be integrated with and/or apart of the controller circuit 536. For example, the operations described being performed by the RF processor 532 may be configured to be performed by the controller circuit 536.

The RF processor 532 may generate different ultrasound image data types, e.g. B-mode, color Doppler (velocity/power/variance), tissue Doppler (velocity), and Doppler energy, for multiple scan planes or different scanning patterns based on the predetermined settings of the first model. For example, the RF processor 532 may generate tissue Doppler data for multi-scan planes. The RF processor 532 gathers the information (e.g. I/Q, B-mode, color Doppler, tissue Doppler, and Doppler energy information) related to multiple data slices and stores the data information, which may include time stamp and orientation/rotation information, in the memory 540.

Alternatively, the RF processor 532 may include a complex demodulator (not shown) that demodulates the RF signal to form IQ data pairs representative of the echo signals. The RF or IQ signal data may then be provided directly to the memory 540 for storage (e.g., temporary storage). Optionally, the output of the beamformer processor 530 may be passed directly to the controller circuit 536.

The controller circuit 536 may include one or more processors. Optionally, the controller circuit 536 may include a central controller circuit (CPU), one or more microprocessors, a graphics controller circuit (GPU), or any other electronic component capable of processing inputted data according to specific logical instructions. Having the controller circuit 536 that includes a GPU may be advantageous for computation-intensive operations, such as volume-rendering. Additionally or alternatively, the controller circuit 536 may execute instructions stored on a tangible and non-transitory computer readable medium (e.g., the memory 540). The controller circuit 536 may be configured to adjust the system settings, image presentation settings, and/or anatomical structures represented by the ultrasound data and/or ultrasound images acquired by the ultrasound imaging system 500. For example, the controller circuit 536 may adjust at least two of adjusting and/or utilizing a contrast of the ultrasound images, the anatomy of interest (e.g., one or more organs, cardiovascular structure), utilizing speckle enhancement, imaging mode (e.g, B-mode, M-mode, color-flow mode, 2D imaging, 3D imaging, 4D imaging), equipment settings, scan angles, time gain compensation, and/or the like Additionally or alternatively, the controller circuit 536 may adjust the system settings and/or image presentation settings of the ultrasound imaging system 500 as described in Harald Lutz et al., WHO Manual of Diagnostic Ultrasound. Vol. 1 (2d ed. 2011), which is incorporated by reference in its entirety.

For example, the controller circuit 536 may be configured to process the acquired ultrasound data (e.g., RF signal data or IQ data pairs) and prepare and/or generate frames of ultrasound image data representing the anatomical structures (e.g., anatomy of interest) for display on the display 538. The controller circuit 536 may adjust the pixels within the frames based on the first model received from the DLCS 110. For example, the first model may include image presentation settings that instruct the controller circuit 536 to adjust the frames of ultrasound image data. The controller circuit 536 may adjust the luminance and/or brightness of the pixels to adjust the contrast of the ultrasound image data, segment portion of the ultrasound image, enhance boundaries of the anatomical structure of the ultrasound image, and/or the like.

In another example, the first model may include the controller circuit 536 to identify speckle patterns within the ultrasound image data by calculating the absolute difference between each pixel. The controller circuit 536 may be configured to enhance the speckle patterns based on the first model, for example, to estimate blood flow.

The controller circuit 536 is configured to perform one or more processing operations according to the predetermined settings of the first model such as plurality of selectable ultrasound modalities or imaging modes (e.g., B-mode, M-mode, color-flow, Doppler) on the acquired ultrasound data, adjust or define the ultrasonic pulses emitted from the transducer elements 524, adjust one or more image display settings of components (e.g., ultrasound images, interface components, positioning regions of interest) displayed on the display 538, and other operations as described herein. Acquired ultrasound data may be processed in real-time by the controller circuit 536 during a scanning or therapy session as the echo signals are received. Additionally or alternatively, the ultrasound data may be stored temporarily in the memory 540 during a scanning session and processed in less than real-time in a live or off-line operation.

The memory 540 may be used for storing processed frames of acquired ultrasound data that are not scheduled to be displayed immediately or to store post-processed images (e.g., shear-wave images, strain images), firmware or software corresponding to, for example, a graphical user interface, one or more default image display settings, programmed instructions, and/or the like. The memory 540 may be a tangible and non-transitory computer readable medium such as flash memory, RAM, ROM, EEPROM, and/or the like.

The memory 540 may store 3D ultrasound image data sets of the ultrasound data, where such 3D ultrasound image data sets are accessed to present 2D and 3D images. For example, a 3D ultrasound image data set may be mapped into the corresponding memory 540, as well as one or more reference planes. The processing of the ultrasound data, including the ultrasound image data sets, may be based in part on user inputs, for example, user selections received at the user interface 542.

The controller circuit 536 is operably coupled to a display 538 and a user interface 542. The display 538 may include one or more liquid crystal displays (e.g., light emitting diode (LED) backlight), organic light emitting diode (OLED) displays, plasma displays, CRT displays, and/or the like. The display 538 may display patient information, ultrasound images and/or videos, components of a display interface, one or more 2D, 3D, or 4D ultrasound image data sets from ultrasound data stored in the memory 540 or currently being acquired, measurements, diagnosis, treatment information, and/or the like received by the display 538 from the controller circuit 536.

Returning to FIG. 4, at 418, the controller circuit 202 is configured to monitor use of the first model. For example, when one or more of the predetermined settings (e.g., system settings, image presentation settings, and/or anatomical structure) of the medical diagnostic imaging systems 102a-f is adjusted by the user, the medical diagnostic imaging systems 102a-f may be configured to transmit adjustments to the predetermined settings within a data packet transmitted along the bi-directional communication links 103 to the DLCS 110. The controller circuit 202 may be configured to monitor the bi-directional communication links 103 for data packets received along the bi-directional communication links 103 that include adjustments to the predetermined settings of the first model by the user.

At 420, the controller circuit 202 may determine whether an adjustment to the predetermined settings have been received. In connection with FIG. 5, the controller circuit 536 (FIG. 5) may be configured to monitor the user interface 542 for adjustments to the predetermined settings (e.g., system settings, image presentation settings, and/or anatomical structures) of the ultrasound imaging system 500. For example, the user interface 542 controls operations of the controller circuit 536 and is configured to receive inputs from the user. The user interface 542 may include a keyboard, a mouse, a touchpad, one or more physical buttons, and/or the like. Based on selections received by the user interface 542 related to the system settings, image presentation settings, and/or anatomical structures representing the predetermined settings, the controller circuit 536 may transmit the adjustments and/or the adjusted predetermined settings along the bi-directional communication link 103 to the DLCS 110. The controller circuit 202 (FIG. 2) may be configured to partition the adjustments to the predetermined settings from data packet received along the bi-directional communication link 103. Additionally or alternatively, the controller circuit 202 may compare the adjusted predetermined settings with the predetermined settings of the first model. Differences between the predetermined settings may indicate to the controller circuit 202 that adjustments to the predetermined settings have been received.

If the adjustments to the predetermined setting are received, then at 422, the controller circuit 202 may determine if the adjustment is above a cluster threshold. The cluster threshold may be configured to gauge a magnitude of an adjustment for the controller circuit 202 to the predetermined settings. In at least one embodiment, the cluster threshold may be based on a variance determined by the controller circuit 202 utilizing K-means clustering. The variance representing a distance between the data values and the center of the cluster.

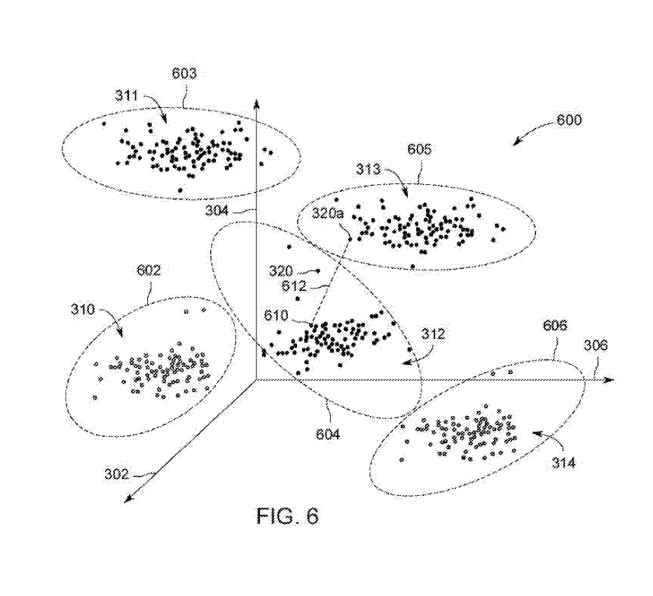

FIG. 6 illustrates a graphical representation 600 of data values grouped into corresponding clusters 310-314, in accordance with an embodiment. Each of the clusters 310-314 may be bounded by the cluster thresholds 602-606. The cluster thresholds 602-606 may be configured to represent a set distance greater than the variance, such as a percentage, set magnitude, and/or the like. The controller circuit 202 may adjust the data value 320, which represents the select user preferences, based on the adjustment to the predetermined settings received by the user to the data value 320a. Based on the change in position of the data value 320a, the controller circuit 202 may determine a distance 612 between the adjusted data value 320 with a center 610 of the cluster 312, and compare the distance 612 with the cluster threshold 604. If the distance 612 is greater than the cluster threshold 604, the controller circuit 202 may determine that the adjustment is above the cluster threshold 604.

If the adjustment is not above the cluster threshold, then at 424, the controller circuit 202 is configured to adjust the data value 320 of the select user preference based on the adjustment. For example, the controller circuit 202 may adjust a position of the data value 320 within the user cluster 312 representing the adjustment to the predetermined settings received by the controller circuit 202.

At 426, the controller circuit 202 is configured to update the first model based on the adjustment to the predetermined settings. For example, based on the adjusted selected user preferences representing the adjusted data value 320, the controller circuit 202 may update the first model utilizing the machine learning algorithms 208 based on the adjusted position of the data value 320. Additionally or alternatively, the controller circuit 202 may receive adjusted predetermined settings from multiple users, based on the select user preferences represented by the data values within the user cluster 312.

If the adjustment is above the cluster threshold, then at 428, the controller circuit 202 is configured to adjust the user preference to an alternative cluster. For example, the controller circuit 202 may determine that the adjusted data value 320a is above the cluster threshold 604. The controller circuit 202 may re-execute the K-means clustering to re-group the data values into clusters based on the adjusted data value 320a. For example, the controller circuit 202 may determine that the adjusted data value 320a may be grouped with the user cluster 313.

At 430, the controller circuit 202 is configured to assign a second model from the models to the user based on the data values for the select user preference. For example, the controller circuit 202 may assign a second model defined by the select user preferences of the user cluster 313.

It may be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid-state drive, optical disk drive, and the like. The storage device may also be other similar means for loading computer programs or other instructions into the computer or processor.

As used herein, the term “computer,” “subsystem” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming The processing of input data by the processing machine may be in response to operator commands, or in response to results of previous processing, or in response to a request made by another processing machine.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein. Instead, the use of “configured to” as used herein denotes structural adaptations or characteristics, and denotes structural requirements of any structure, limitation, or element that is described as being “configured to” perform the task or operation. For example, a controller circuit, processor, or computer that is “configured to” perform a task or operation may be understood as being particularly structured to perform the task or operation (e.g., having one or more programs or instructions stored thereon or used in conjunction therewith tailored or intended to perform the task or operation, and/or having an arrangement of processing circuitry tailored or intended to perform the task or operation). For the purposes of clarity and the avoidance of doubt, a general purpose computer (which may become “configured to” perform the task or operation if appropriately programmed) is not “configured to” perform a task or operation unless or until specifically programmed or structurally modified to perform the task or operation.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments without departing from their scope. While the dimensions and types of materials described herein are intended to define the parameters of the various embodiments, they are by no means limiting and are merely exemplary. Many other embodiments will be apparent to those of skill in the art upon reviewing the above description. The scope of the various embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f) unless and until such claim limitations expressly use the phrase “means for” followed by a statement of function void of further structure.

This written description uses examples to disclose the various embodiments, including the best mode, and also to enable any person skilled in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal language of the claims.

What is claimed is:

1. A computer implemented method, comprising:
maintaining models with predetermined settings for at least one of system settings, image presentation settings, or anatomical structures;
calculating a data value representing select user preferences for a first user;
identifying a first cluster based on the data value;
assigning a first model from the models to the first user based on the first cluster;
monitoring use of the first model by the first user during a medical diagnostic application to determine whether the first model is updated by the first user or automatically during the medical diagnostic application by changing at least one of system settings, image presentation settings, or anatomical structures.

2. The computer implemented method of claim 1, further comprising determining when the first user modifies the data value for the first user preference relative to a cluster threshold, and based on the determining operation moving the data value to a second cluster.

3. The computer implemented method of claim 1, further comprising grouping data values from multiple users into the first cluster, wherein the data values from the multiple users fall within a variance based on the first cluster.

4. The computer implemented method of claim 3, further comprising defining the first model based on the data values from the multiple users.

5. The computer implemented method of claim 1, further comprising configuring a medical diagnostic imaging system utilizing i) the data value for the first user preference and ii) the predetermined settings for at least one of system settings, image presentation settings, or anatomical structures from the first model

6. The computer implemented method of claim 1, further comprising receiving an adjustment to the predetermined settings, and adjusting the data value of the first user based on the adjustment to the predetermined settings.

7. The computer implemented method of claim 1, wherein the first cluster includes data values of select user preferences for multiple users.

8. The computer implemented method of claim 7, further comprising updating the first model based on changes in the data values for the first cluster from the multiple users.

9. The computer implemented method of claim 1, further comprising receiving responses to predetermined questions from the first user and parsing the responses for the first user to identify the select user preferences.

10. The computer implemented method of claim 1, wherein the predetermined settings comprise at least two of i) utilizing contrast, ii) an anatomy of interest, iii) utilizing speckle enhancement, iv) imaging mode, v) equipment settings, vi) scan angles, or vii) time gain compensation.

11. A distributed learning central system comprising:
a communication circuit communicatively coupled to a plurality of medical diagnostic imaging systems; and
a controller circuit configured to:
maintain models with predetermined settings for at least one of system settings, image presentation settings, or anatomical structures;
calculate a data value representing select user preferences for a first user;
identify a first cluster based on the data value;
assign a first model from the models to the first user based on the first cluster;
monitor use of the first model by the first user during a medical diagnostic application to determine whether the first model is updated by the first user by changing at least one of system settings, image presentation settings, or anatomical structures.

12. The distributed learning central system of claim 11, wherein the controller circuit is configured to determine when the first user modifies the data value for the first user preference relative to a cluster threshold, and move the data value to a second cluster.

13. The distributed learning central system of claim 11, wherein the controller circuit is configured to group data values from multiple users into the first cluster, wherein the data values from the multiple users fall within a variance based on the first cluster.

14. The distributed learning central system of claim 13, wherein the controller circuit is configured to define the first model based on the data values from the multiple users.

15. The distributed learning central system of claim 11, wherein the controller circuit is configured to transmit the first model to a first medical diagnostic imaging system, wherein the first medical diagnostic imaging system is configured based on the first model.

16. The distributed learning central system of claim 11, wherein the controller circuit is configured to receive an adjustment to the predetermined settings, and adjust the data value of the first user based on the adjustment to the predetermined settings.

17. The distributed learning central system of claim 11, wherein the first cluster includes data values of select user preferences for multiple users.

18. The distributed learning central system of claim 11, wherein the controller circuit is configured to receive responses to predetermined questions from the first user and parse the responses for the first user to identify the select user preferences.

19. The distributed learning central system of claim 11, wherein the predetermined settings comprise at least two of i) utilizing contrast, ii) an anatomy of interest, iii) utilizing speckle enhancement, iv) imaging mode, v) equipment settings, vi) scan angles, or vii) time gain compensation.

20. A tangible and non-transitory computer readable medium comprising one or more programmed instructions configured to direct one or more processors to:
maintain models with predetermined settings for at least one of system settings, image presentation settings, or anatomical structures;
calculate a data value representing select user preferences for a first user;
identify a first cluster based on the data value;
assign a first model from the models to the first user based on the first cluster;
monitor use of the first model by the first user during a medical diagnostic application to determine whether the first model is updated by the first user by changing at least one of system settings, image presentation settings, or anatomical structures.
